(19) United States
(12) Patent Application Publication
(10) Pub. No.: US 2016/0085321 A1
(43) Pub. Date: Mar. 24, 2016

(54) DIAL-TYPE CONTROL APPARATUS, VEHICLE HAVING THE SAME, AND METHOD OF CONTROLLING THE VEHICLE

(71) Applicant: HYUNDAI MOTOR COMPANY, Seoul (KR)

(72) Inventor: Nam Kwon JUNG, Yongin-si (KR)

(21) Appl. No.: 14/566,575

(22) Filed: Dec. 10, 2014

(30) Foreign Application Priority Data
Sep. 23, 2014 (KR) 10-2014-0126900

(51) Int. Cl. G06F 3/0362; G06F 3/02; G06F 3/0338

(52) U.S. Cl. CPC G06F 3/0362; G06F 3/0338; G06F 3/0202

(57) ABSTRACT

A dial-type control apparatus includes a lower body, an upper body provided to rotate relative to the lower body, and a touch sensitive member installed at the upper body and configured to be rotated together with the upper body and to receive a touch signal of a user.

### CROSS-REFERENCE TO RELATED APPLICATION

This application claims the benefit of priority to Korean Patent Application No. 2014-0126900, filed on Sep. 23, 2014, in the Korean Intellectual Property Office, the disclosure of which is incorporated herein by reference.

### TECHNICAL FIELD

Present disclosure relates to a dial-type control apparatus, a vehicle having the same, and a control method of the vehicle, and more particularly, a dial-type control apparatus through which commands associated with manipulating a vehicle or providing convenience of passengers are input, a vehicle having the dial-type control apparatus, and a control method of the vehicle.

### BACKGROUND

As multimedia apparatuses being used for vehicles are varied and functions of the multimedia apparatuses are increased as well, the degree of complexity in operation by a user is increased, and thus, as part of the efforts in simplifying the operation, an application of an interface configured for an integrated usage is increased, and a typical case of the application may be referred to as a dial-type control apparatus, such as a Jog Dial.

Conventionally, in a case when a passenger manually rotates a dial-type control apparatus in a forward direction or a backward direction, the dial-type control apparatus is provided as to select functions of multimedia devices that are being used for a vehicle and perform operations according to the selected functions, by being in mechanically electrical contact during the rotation.

The dial-type control apparatus, in a case when list is being searched or values are needed to be continuously changed, when compared to a button-type input apparatus, the execution time is short while usage convenience is high, and is configured to be intuitively manipulated.

### SUMMARY

In accordance with one aspect of the present inventive concept, a dial-type control apparatus includes a lower body; an upper body configured to rotate relative to the lower body; and a touch sensitive member installed at the upper body and configured to rotate together with the upper body and to receive a touch signal of a user.

The dial-type control apparatus may further include: a first sensor provided at one of the upper body and the lower body; and a second sensor provided at the other one of the upper body and the lower body, wherein relative positions of the upper body and the lower body may be identified by use of a sensing operation between the first sensor and the second sensor.

A handle surface configured to deliver rotational force by a user may be provided at an outer circumferential surface of the upper body, and the touch sensitive member may include a touch pad portion accommodated in a touch pad accommodation groove provided at an upper portion of the upper body.

A first toothed surface may be provided at the upper body, and a second toothed surface configured to be matingly-coupled to the first toothed surface may be provided at the lower body. The first sensor may include a plurality of sensor components disposed at an outer circumference of the upper body or the lower body at equal intervals.

The first sensor may include a plurality of sensor components provided at an outer circumference of the upper body or the lower body, where each sensor component may be distinguished by a unique sign corresponding to a unique signal. The second sensor may be configured to connect to each of the sensor components of the first sensor and to transmit the corresponding unique signal.

The first sensor may be provided with a plurality of resistors each having a different resistance and the second sensor may be configured to conduct a current when connected to the first sensor.

An upper portion surface of the touch sensitive member may be provided with a higher height or an identical height than one end portion of the handle surface.

The handle surface may be provided with an inclination being inclinedly provided from an outer side of the touch sensitive member.

In accordance with another aspect of the present inventive concept, a vehicle includes: a dial-type control apparatus
having a lower body,
an upper body configured to be rotated relative to the lower body,
a touch sensitive member installed at the upper body and configured to be rotated together with the upper body and to receive a touch signal of a user,

a first sensor provided at one of the upper body and the lower body; and

a second sensor provided at the other one of the upper body and the lower body. A controller may be configured to recognize information regarding a degree of rotation of the upper body transmitted as a result of a sensing operation between the first sensor and the second sensor.

The vehicle may further include a direction sensor configured to recognize a rotational direction of the upper body. The first sensor may include a plurality of sensor components provided at an outer circumference of the upper body or the lower body at equal intervals. The second sensor may be configured to transmit a signal by recognizing the first sensor. The controller may be configured to recognize the information about the degree of rotation of the upper body through a direction sensor signal being transmitted from the direction sensor and a second sensor signal being transmitted from the second sensor.

The first sensor may include a plurality of sensor components provided at an outer circumference of the upper body or the lower body as to be distinguished by unique signs corresponding to unique signals. The second sensor may be configured to connect to each of the sensor components of the first sensor and to transmit the corresponding unique signal. The controller may be configured to recognize the information about the degree of rotation of the upper body through a signal being transmitted from the second sensor.

The direction sensor may include a plurality of resistors each having a different resistance provided at a one of the upper body and the lower body. A resistance sensor may be provided at the other one of the upper body and the lower body allowing a current to flow through the resistance sensor when connected to at least one resistor.

In accordance with another aspect of the present inventive concept, a method of controlling a vehicle provided with a dial-type control apparatus including a lower body and an upper body rotatably coupled to the lower body is disclosed. The method may include: sensing a degree of rotation of the upper body;

recognizing touching manipulations with respect to a touch sensitive member provided at the upper body; calibrating the touch manipulations according to the degree of the rotation of the upper body, and executing a control method of the vehicle according to the touch manipulations.

In the step of sensing the degree of rotation of the upper body, relative positions of the upper body and the lower body may be sensed by use of a sensing operation between a first sensor provided at one of the upper body and the lower body and a second sensor provided at the other one of the upper body and the lower body.

The step of sensing the degree of rotation of the upper body may also include recognizing a signal transmitted by the second sensor, wherein the step of sensing the relative positions of the upper body and the lower body is based on the step of recognizing.

### BRIEF DESCRIPTION OF THE DRAWINGS

These and/or other aspects of the inventive concept will become apparent and more readily appreciated from the following description of the embodiments, taken in conjunction with the accompanying drawings of which:

FIG. 1 is an exterior view of a vehicle in accordance with one embodiment of the present inventive concept.

FIG. 2 is a drawing showing a structure of an inside the vehicle in accordance with one embodiment of the present inventive concept.

FIG. 3 is a drawing showing a gear box in accordance with one embodiment of the present inventive concept.

FIG. 4 and FIG. 5 are drawings showing an input apparatus in accordance with one embodiment of the present inventive concept.

FIG. 6 is a usage view illustrating an image of manipulating a dial-type control apparatus having a touch sensitive member in accordance with a comparative example.

FIG. 7 is a usage view illustrating an image of manipulating the dial-type control apparatus in accordance with one embodiment of the present inventive concept.

FIG. 8 is a conceptual diagram showing differences in inputting characters according to rotations of a touch sensitive member.

FIG. 9 is an exploded perspective view showing the dial-type control apparatus in accordance with one embodiment of the present inventive concept.

FIG. 10 is an exploded cross-sectional view showing a coupling image of the dial-type control apparatus in accordance with one embodiment of the present inventive concept.

FIG. 11 to FIG. 14 are drawings showing driving images of the dial-type control apparatus in accordance with one embodiment of the present inventive concept.

FIG. 15 is a drawing showing an image of transmitting signals of the vehicle in accordance with one embodiment of the present inventive concept.

FIG. 16 is a drawing showing an image of transmitting signals of a vehicle in accordance with another embodiment of the present inventive concept.

FIG. 17 is a flow chart showing a control method of the vehicle in accordance with one embodiment of the present inventive concept.

### DETAILED DESCRIPTION

Reference will now be made in detail to the embodiments of the present inventive concept, examples of which are illustrated in the accompanying drawings, wherein like reference numerals refer to like elements throughout.

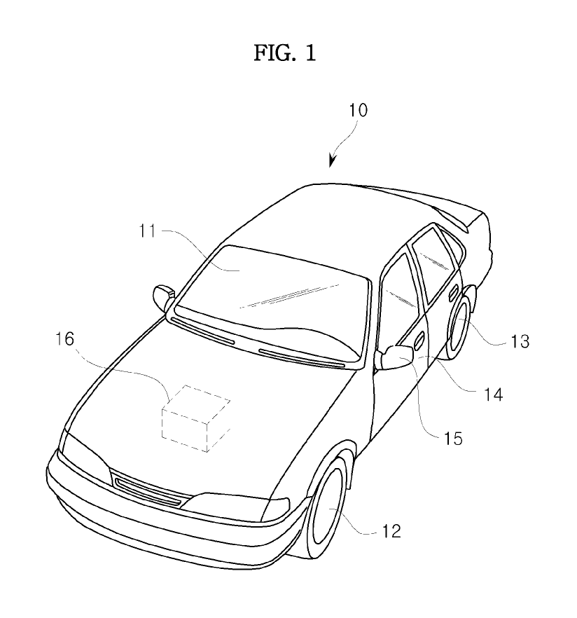

FIG. 1 is an exterior view of a vehicle in accordance with one embodiment of the present inventive concept.

Referring to FIG. 1, a vehicle in accordance with one embodiment of the present inventive concept includes a vehicle body 10 forming an exterior appearance of the vehicle, vehicular wheels 12 and 13 to move the vehicle, a driving apparatus 16 to rotate the vehicular wheels 12 and 13, doors 14 to open/close with respect to an inside the vehicle from outside, a front glass 11 to provide a view of a front of the vehicle to a driver at the inside the vehicle, and side mirrors 15 to provide views of a rear of the vehicle to the driver.

The vehicular wheels 12 and 13 includes front vehicular wheels 12 provided at a front of the vehicle and rear vehicular wheels 13 provided at a rear of the vehicle, and the driving apparatus 16 is configured to provide rotational force to the front vehicular wheels 12 or to the rear vehicular wheels 13 such that the vehicle body 10 is moved forward or backward. The driving apparatus 16 as such may employ an engine configured to generate the rotational force by combusting fossil fuel, or a motor configured to generate the rotational force while provided with a power from a capacitor (not shown).

The doors 14 are rotatably provided at a left side and a right side of the vehicle body 10 such that the driver may enter the inside the vehicle at the time when the door 14 is open, and are configured to close the inside the vehicle from an outside at the time when the doors 14 are closed.

The front glass 11 is provided at an upper side of a front of the vehicle body 10 such that the driver at the inside the vehicle may be able to obtain visual information of a front of the vehicle, and is also referred to as a windshield glass.

In addition, the side mirrors 15 includes a left side mirror provided at a left side of the vehicle body 10 and a right side mirror provided at a right side of the vehicle body 10, and is configured such that the driver at the inside the vehicle may be able to obtain visual information of sides and a rear of the vehicle.

Other than the above, the vehicle may include a proximity sensor configured to sense obstacles or other vehicles at a rear of the vehicle, and a rain sensor configured to sense the presence of rain or snow and the amount of the rain or snow.

As one example of the proximity sensor, the proximity sensor is configured to transmit sense signals toward sides or a rear of the vehicle, and receive reflection signals being reflected from obstacles such as other vehicles. In addition, the proximity sensor is capable of sensing the presence of obstacles at a rear of the vehicle based on the waveforms of the reflection signals that are received, and then is capable of detecting the position of the obstacles. The proximity sensor as such may employ a method of detecting the distance from the obstacles by use of reflected ultrasonic waves from the obstacles after transmitting the ultrasonic waves.

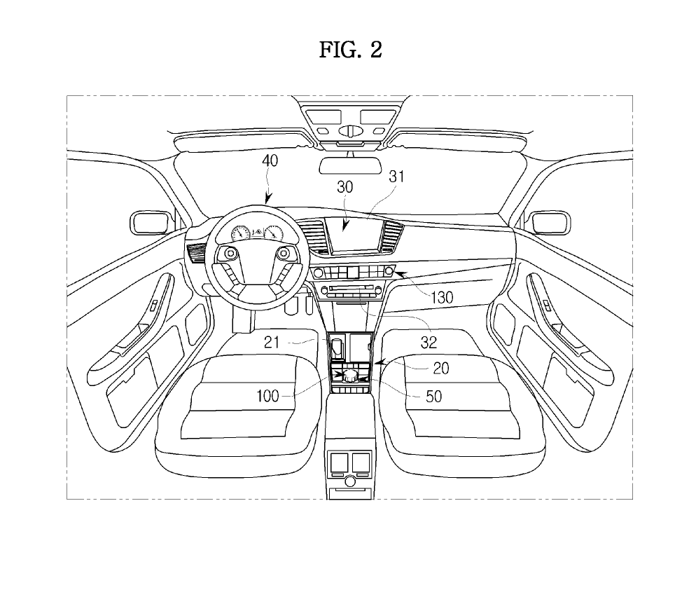

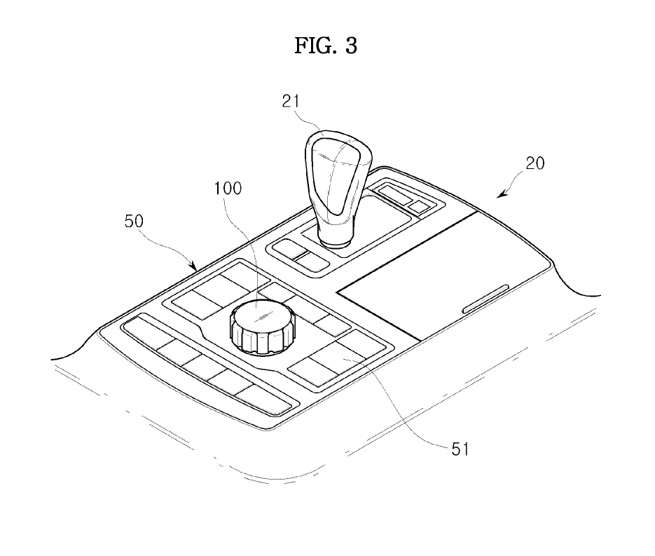

FIG. 2 is a drawing showing a structure of the inside the vehicle in accordance with one embodiment of the present inventive concept, and FIG. 3 is a drawing showing a gear box 20 in accordance with one embodiment of the present inventive concept.

Referring to the illustration on FIG. 2, the vehicle may include a dashboard having provided with the gearbox 20, a center fascia 30, and a steering wheel 40.

A gear stick controlling 21 a transmission gear configured to change speed of the vehicle is installed at the gear box 20. In addition, as illustrated on the drawing, an input apparatus 50 configured to control the execution of a navigation apparatus 31 or key functions of the vehicle by a user may be installed at the gear box 20.

An air conditioning apparatus, a clock, an audio apparatus, and the navigation apparatus 31 may be installed at the center fascia 30. The air conditioning apparatus is configured to maintain the inside the vehicle in a pleasant manner by adjusting the temperature, humidity, cleanliness of air, and flow of the air at the inside the vehicle. The air conditioning apparatus may include at least one discharging unit installed at the center fascia 30, and configured to discharge the air. Buttons or dials configured to control the air conditioning apparatus may be installed at the center fascia 30. A user such as the driver may be able to control the sir conditioning apparatus of the vehicle by use of the buttons or the dials that are disposed at the center fascia 30.

The navigation apparatus 31 may be installed at the center fascia 30 in accordance with an embodiment of the present inventive concept. The navigation apparatus 31 may be embedded inside the center fascia 30 of the vehicle. An input unit configured to control the navigation apparatus 31 may be installed at the center fascia 30 in accordance with one embodiment of the present inventive concept. The input unit of the navigation apparatus 31 may be installed at a different position other than at the center fascia 30 in accordance with an embodiment of the present inventive concept. For example, the input unit of the navigation apparatus 31 may be formed at the surroundings of a display unit of the navigation apparatus 31. In addition, as another example, the input unit of the navigation apparatus 31 may be installed at the gear box 20.

The steering wheel 40 is referred to as an apparatus configured to adjust driving directions of the vehicle, and may include a rim as to be gripped by the driver and a spoke connected to a steering apparatus of the vehicle and provided as to be connected to hub of a rotational axis that is configured to steer with respect to the rim. A manipulating apparatus configured to control various apparatus, such as the audio apparatus, at the inside the vehicle may be formed at the spoke.

In addition, the dashboard in accordance with an embodiment of the present inventive concept may further include various instrument panels capable of displaying driving speed, number of rotations of an engine, and amount of remaining fuel of the vehicle, as well a globe box capable of storing various materials.

The audio apparatus 32 includes a manipulation panel provided with a number of buttons configured to perform various functions. The audio apparatus is capable of providing a radio mode to offer radio functions and a media mode to replay audio files of various storage mediums having the audio files. The buttons formed at the manipulation panel of the audio apparatus 32 may be distinguished into the buttons configured to provide functions related to the performing of the radio mode, the buttons being configured to provide functions related to the performing of the media mode, and the buttons being commonly used for the both of the radio mode and the media mode.

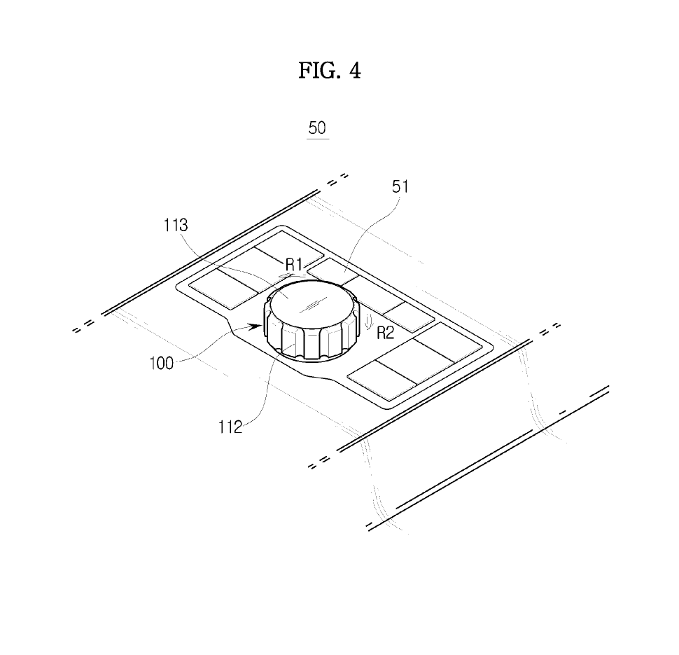

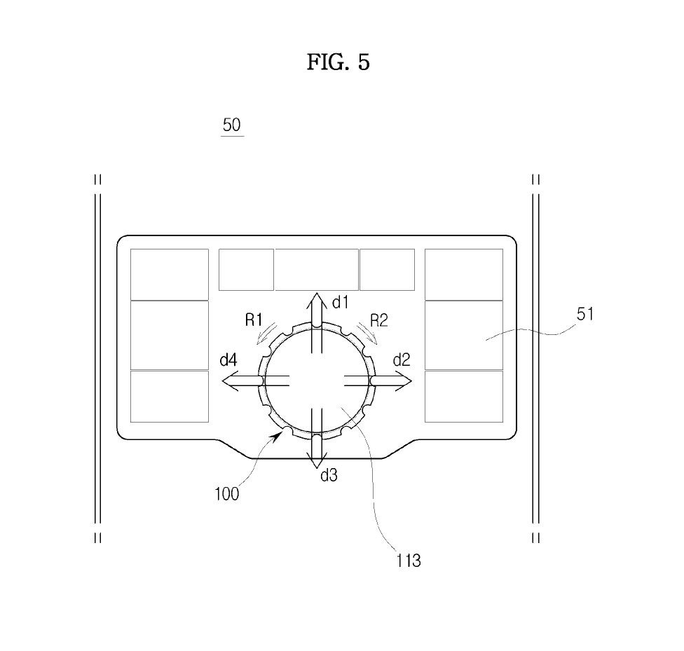

The input apparatus 50 in accordance with one embodiment of the present inventive concept will be described in detail by referring to FIG. 4 and FIG. 5. FIG. 4 and FIG. 5 are drawings showing the input apparatus in accordance with one embodiment of the present inventive concept.

The input apparatus 50 in accordance with one embodiment of the present inventive concept includes a dial-type control apparatus 100 which may be rotatably manipulated, and as illustrated on FIG. 3, the dial-type control apparatus 100 may be installed at the gear box 20 at the inside the vehicle. The gear box 20 may generally be installed in between a driver's seat and a passenger's seat at the inside the vehicle, and a gear stick 21 and various parts related to change of speed may be embedded.

Various buttons may be installed at an outside the gear box 20 in accordance with an embodiment of the present inventive concept. The dial-type control apparatus 100 may be provided in a knob type such that a user may be able to grip by use of a hand and rotatably manipulate. The various buttons 51 configured to assist functions of the dial-type control apparatus 100 or to perform independent functions separately may be provided at the surroundings of the dial-type control apparatus 100.

As illustrated on FIG. 4, the dial-type control apparatus 100 is provided as to be rotatably manipulated toward predetermined directions R1 and R2 along a predetermined rotational axis. In addition, as illustrated on FIG. 5, the dial-type control apparatus 100 may be inclined or moved toward at least one of directions d1, d2, d3, and d4 while having a central axis of the dial-type control apparatus 100 as a reference. As illustrated on FIG. 5, for example, the dial-type control apparatus 100 may be inclined toward the forward, backward, left, and right directions. In other words, the dial-type control apparatus 100 may be inclined toward the d1, d2, d3, and d4 directions. The dial-type control apparatus 100 may also be inclined toward further various directions in accordance with an embodiment of the present inventive concept. A user may be able to input a predetermined instruction or command by rotating the dial-type control apparatus 100 or by inclining the dial-type control apparatus 100 toward a particular direction.

In addition, a touch sensitive member 113 configured such that an input is enabled through a touch may be provided at an upper surface of the dial-type control apparatus 100. A user may be able to input a desired instruction or command by inputting a predetermined touch gesture at the touch sensitive member 113 of the dial-type control apparatus 100. The touch sensitive member 113 may be implemented with various methods of a published touch panel_{[SS1]} such as a decompressed touch panel or a capacitive touch panel.

The dial-type control apparatus 100 may be provided with various parts embedded at an inside thereof while the various parts are related to various motions and a rotational axis member into which the dial-type control apparatus 100 is rotatably coupled and various parts, for example, a bearing, that are related to such may be installed at the inside the dial-type control apparatus 100. The rotational axis member, while provided with a structure capable of tilting the dial-type control apparatus 100 toward the four directions including the d1, d2, d3, and d4 as described above, is tilted by use of a driving force being supplied by use of a motor (not shown).

In addition, various semiconductor chips and printed circuit boards may be installed at an inside the dial-type control apparatus 100. The semiconductor chip may be mounted on a printed circuit board. The semiconductor chip is capable of performing data processing or storing data. The semiconductor chip is capable of interpreting predetermined electrical signals that are generated according to motions of the dial-type control apparatus 100 or manipulations of the buttons formed at the dial-type control apparatus 100, generating predetermined control signals according to the interpreted contents, and delivering the control signals to a controller or the display unit.

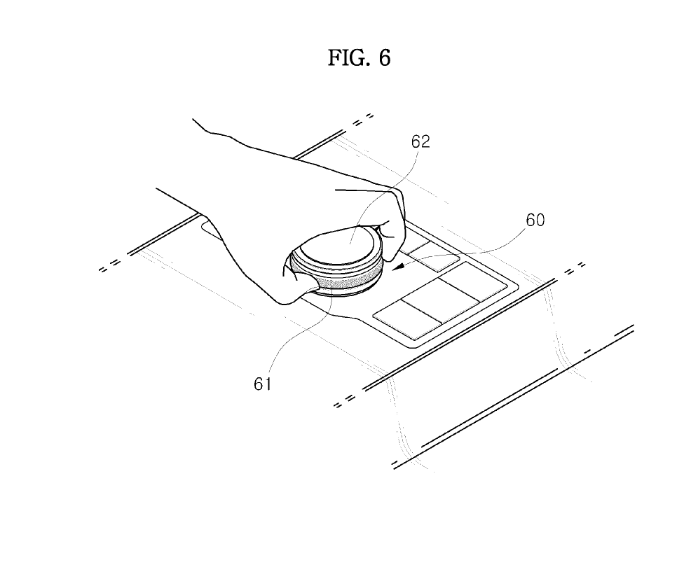

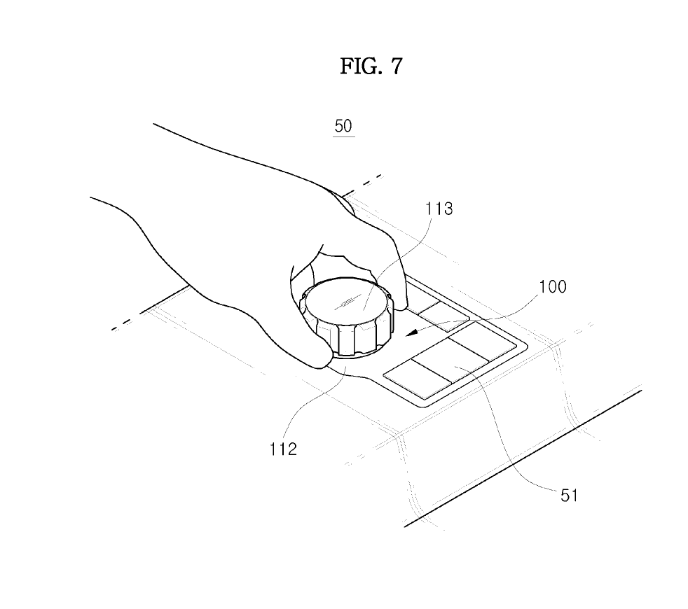

By comparing FIG. 6 and FIG. 7, the characteristics of the dial-type control apparatus 100 in accordance with one embodiment of the present inventive concept will be described. FIG. 6 is a usage view illustrating an image of manipulating a dial-type control apparatus 60 having a touch sensitive portion 62_{[SS2]} in accordance with comparative example, and FIG. 7 is a usage view illustrating an image of manipulating the dial-type control apparatus 100 in accordance with one embodiment of the present inventive concept.

FIG. 6 shows comparitive example of the dial-type control apparatus 60 having a touch panel. With respect to the dial-type control apparatus 60 illustrated on FIG. 6, the touch sensitive portion 62 provided at an upper portion and a handle portion 61 provided at an outer circumference are independently coupled. That is, the touch sensitive portion 62 is fixedly positioned at a body, and the handle portion 61 is coupled such that the handle portion 61 may be able to be rotated at the surroundings of a body and the touch sensitive portion 62.

However, as for a user to operate the dial-type control apparatus 60, the handle portion 61 below the touch sensitive portion 62 is needed to be gripped and rotated, and thus an inconvenience may be occurred by an awkward hand posture as shown on the drawing, and thereby a natural gripping or sense of manipulation may be absent.

If in a case when the touch sensitive portion 62 is provided to be at an inner side of the handle portion 61 as to enhance the sense of manipulation, the area of the touch sensitive portion 62 is reduced, as the structures are needed to be interposed in between the touch sensitive portion 62 and the handle portion 61 as to be independently rotated.

Compared to the above, with respect the dial-type control apparatus 100 in accordance with one embodiment of the present inventive concept illustrated on FIG. 7, the touch sensitive member 113 and the handle surface 112 are provided to be rotated along with each other. Thus, members configured for rotational motions are not needed to be separated inserted into in between the touch sensitive member 113 and the handle surface 112, and thereby the area of the touch sensitive member 113 may be maximized. In addition, the sense of gripping and manipulation of a user may be enhanced as the handle surface 112 is provided as to wrap around an outer side of the touch sensitive member 113.

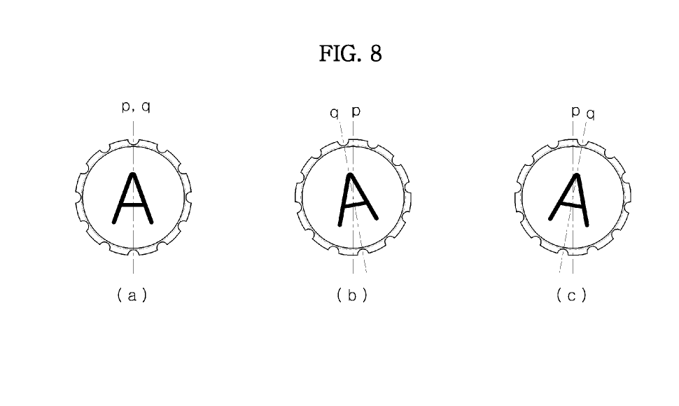

FIG. 8 is a conceptual diagram showing differences in inputting characters according to rotations of the touch sensitive member, and an (a) is referred to as a case when a gesture is input according to a reference direction, a (b) is referred to as a case when a gesture is input at a rotated angle of about 10 degrees toward counter-clockwise direction from the reference direction, and a (c) is referred to as a case when a gesture is input at a rotated angle of about 10 degrees toward clockwise direction from the reference direction.

The gesture of a user being input at the touch sensitive member 113 may be recognized while having the reference direction, as one example, a p-axis direction on the drawing, as a reference. A case of the gesture being input according to the reference direction ‘p’ is illustrated on the (a) of FIG. 8. However, in a case when the touch sensitive member 113 and the handle surface 112 are provided to be integrally rotated, when the handle surface 112 is rotated by a user, a dislocation of an input direction of the gesture being input from the touch sensitive member 113, as one example, toward a q-axis direction on the drawing, may occur with respect to the reference direction ‘p’. The input direction ‘q’ of the gesture is referred to as the reference direction that the user desires.

In a case when the gesture of a user is input while rotated toward a clockwise direction or counter-clockwise direction from the reference direction ‘p’, the rate of acknowledgement is rapidly reduced. Thus, a need is occurred as to solve the dislocation of the input direction ‘q’ of the gesture being input as the touch sensitive member 113 is rotated along with the handle surface 112 with respect to the reference direction ‘p’.

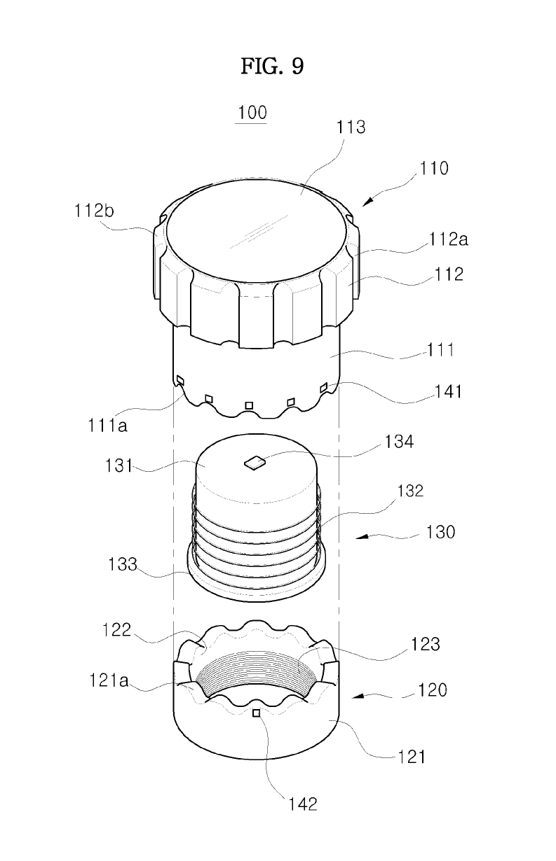

With respect to the dial-type control apparatus 100 in accordance with one embodiment of the present inventive concept, even in a case when the touch sensitive member 113 is rotated by a manipulation of a user, the degree of rotation of the touch sensitive member 113 with respect to the reference direction may be recognized, and the rate of acknowledgment may be maintained at a maximum level by calibrating the input direction ‘q’ of the gesture to the reference direction ‘p’. The detailed description of the above will be provided by referring to FIG. 9 to FIG. 12.

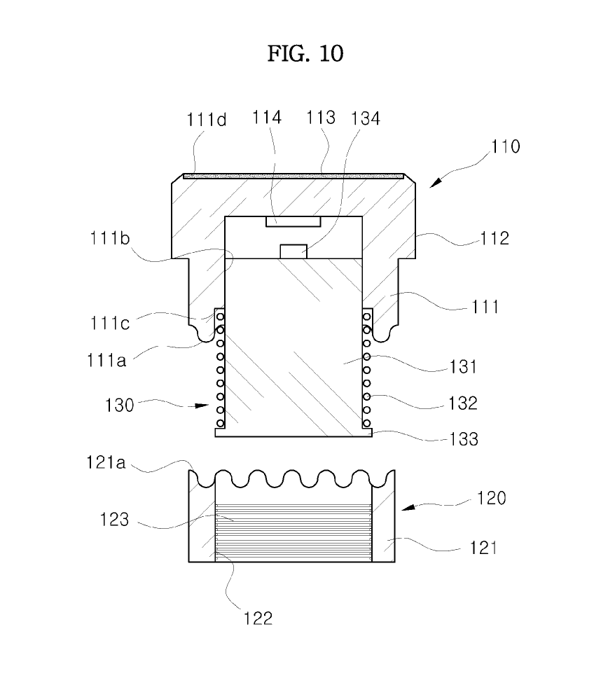

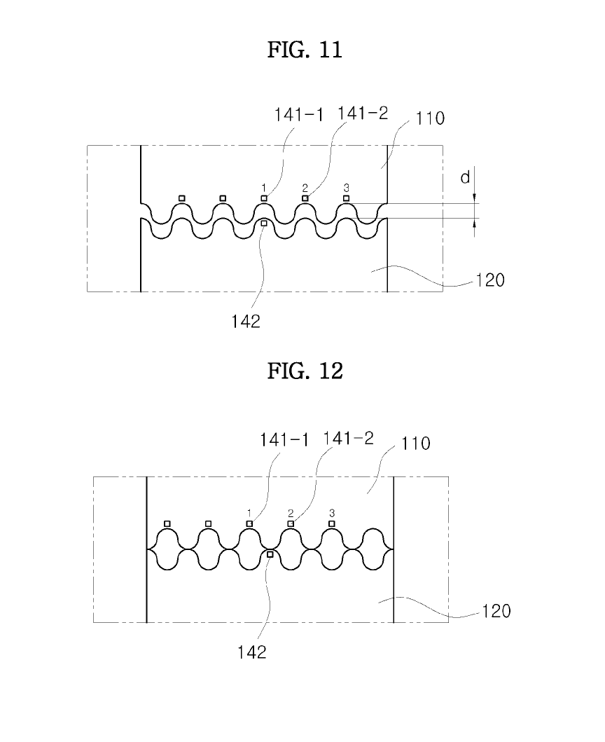

FIG. 9 is an exploded perspective view showing the dial-type control apparatus 100 in accordance with one embodiment of the present inventive concept, FIG. 10 is an exploded frontal view showing a coupling image of the dial-type control apparatus 100 in accordance with one embodiment of the present inventive concept, and FIG. 11 and FIG. 12 are frontal views showing driving images of the dial-type control apparatus 100 in accordance with one embodiment of the present inventive concept.

The dial-type control apparatus 100 in accordance with one embodiment of the present inventive concept may include an upper body 110, a lower body 120, and a core 130 accommodated at the upper body 110 and the lower body 120.

The upper body 110 may include a upper body member 111 provided in the shape of a cylinder, the handle surface 112 provided at an outer circumference of the upper body member 111 such that a user may grip, and the touch sensitive member 113 provided at an upper portion of the upper body member 111.

The upper body member 111 is provided with an opening unit at a lower side thereof such that the core 130 is inserted thereinto, and the opening unit is extended to a core accommodation unit 111b provided as to accommodate an upper end of the core 130. A first toothed surface 111a in the shape of a wave may be formed at a lower end portion of the upper body member 111. The handle surface 112 is configured to deliver rotational force while the handle surface 112 is gripped by a user, and may be provided with a groove 112a at a surface thereof as to improve the sense of grip.

The touch sensitive member 113 may include a touch pad portion being accommodated at a touch pad accommodation groove 111d formed at an upper end of the upper body member 111. The touch panel may be provided as to acknowledge gestures of a user as well as contacts of a user. As one example, a user may be able to input predetermined gestures that correspond to motion signals, or may be able to input characters, numbers, or figures.

The handle surface 112 may be provided not to be protruded in a longitudinal direction of the dial-type control apparatus 100 from an upper surface of the touch sensitive member 113. That is, an upper surface of the handle surface 112 may be flush with the upper surface of the touch sensitive member 113 or lower than the upper surface the touch sensitive member 113. In addition, an inclination 112b may be provided at an upper portion of an outer side of the handle surface 112 such that an inconvenience that a user may feel while the handle surface 112 is interfered when the touch sensitive member 113 is manipulated by the user may be prevented.

Meanwhile, an outer side surface of the handle surface 112 may be provided to be protruded from an external diameter of the touch unit 113, such that an inconvenience that a user may feel while the touch unit 113 is interfered when the handle surface 112 is gripped by the user as to apply rotational force may be prevented.

The lower body 120 may include a lower body member 121 provided in the shape of a cylinder, and a penetration hole 122 configured to accommodate the core 130 may be formed at the lower body member 121. A second toothed surface 121a having the shape of a wave may be provided at an upper end of the lower body member 121. At this time, the second toothed surface 121a is provided to be tooth-coupled with respect to the first toothed surface 111a of the upper body 110.

The core 130 may include a core body member 131 provided in the shape of a cylinder and an elastic member 132 configured to support the upper body 110. The core 130 may be accommodated at the core accommodation groove 111b of the upper body 110 after penetrating through the penetration hole 122 of the lower body 120. The elastic member 132 may be a coil spring provided at an external diameter of the lower body member 121. The elastic member 132 is capable of providing elastic force toward a direction of the upper body 110 is pushed away from the lower body 120, and may employ various shapes and materials including the coil spring. Meanwhile, the core accommodation groove 111b of the upper body 110 and the penetration hole 122 of the lower body 120 may be provided with an internal diameter as to be capable of accommodating the elastic member 132 being provided at an external diameter of the core body member 131 of the core 130.

The core 130 may be provided with a lower end supporting threshold 133 capable of supporting a lower end of the elastic member 132. The lower end supporting threshold 133 may be provided with the shape of a flange being protruded at an external diameter of the core 130. The upper body 110 may be provided with an upper end supporting threshold 111c capable of supporting an upper end of the elastic member 132. The upper end supporting threshold 111c may be provided in the shape of a groove being insertedly input at an internal diameter of the core accommodation groove 111b at which the core 130 is accommodated. That is, the upper end supporting threshold 111c may be provided as a groove having a larger internal diameter than an internal diameter of the accommodation groove 111b of the core 130, and a step may be provided in between the core accommodation groove 111b and the upper end supporting threshold 111c.

The core 130 may be rotatably provided along with the upper body 110 while connected to the upper body 110, or the core 130 may be relatively rotated with respect to the upper body 110 while connected to the lower body 120.

The upper body 110 and the lower body 120 are relatively and rotatably coupled with respect to each other. The upper body 110 may be rotated while having a same axis with respect to the lower body 120 as a center. At this time, the upper body 110 may be tooth-coupled into the lower body 120. As the first toothed surface 111a provided at a lower end of the upper body 110 and the second toothed surface 121a provided at an upper end of the lower body 120 are tooth-coupled with respect to each other, a gradual sense of manipulation may be provided. In addition, as the first toothed surface 111a of the upper body 110 and the second toothed surface 121a of the lower body 120 are provided with the shape of a wave, when the upper body 110 is rotated at the lower body 120, a smooth sense of manipulation may be provided. However, the specific shapes of the first toothed surface 111a and the second toothed surface 121a may be changed according to needs.

The upper body 110 may be provided as to be slidingly moved toward vertical directions along with the core 130 or the lower body 120. The upper body 110 may be rotated along the second toothed surface 121a of the lower body 120 while provided to be vertically moved from a rib of the second toothed surface 121a having the shape of a wave to the height of the ridge. Meanwhile, the upper body 110 may be able to provide a smooth sense of manipulation to a user while provided with elastic force at all times toward upper and lower directions by use of the elastic ember 132. Thus, the user may be able to smoothly rotate the upper body 110 by use of small force of rotational force. At this time, the shapes of the first toothed surface 111a and the second toothed surface 121a as well as the elasticity of the elastic member 132 may be selected as to form a balance in between the gradual sense of manipulation that is being felt at the time of passing over each tooth.

A switch unit 134 and a switch connecting unit 114 capable of sensing a push signal of the upper body 110 may be provided at a contact surface of the upper boy 110 and the core 130. As one example, the switch unit 134 is provided at an upper end of the core 130, and the switch connecting unit 114 may be provided at a surface facing the upper end of the inner core 130 of the upper body 110. In a case when the upper body 110 is applied with a pressure and is pushed by a user, the switch connecting unit 114 is in contact with respect to the switch unit 134, and the switch unit 134 may be able to deliver the signal as such to an outside. At this time, the elastic member 132 may be able to provide a state in which the upper body 110 is being pushed by maintaining the upper body 110 is in a state of being lifted toward an upper direction with respect to the lower body 120.

A coil 123 may be wound at an inner circumference of the penetration hole 122 of the lower body 120. As a power is applied at the coil 123, an electromagnetic force is generated while connected to the upper body 110 or the core 130. The upper body 110 or the core 130 may be provided such that a polarity being reciprocal with respect to the polarity of the power being applied at the coil 123 is applied. As one example, when the upper body 110 is recognized to be at a particular position, a power is applied to the coil 123 and an electromagnetic force is generated, and thus a gravitational force is generated in between the upper body 110 and the lower body 120 so that the movements of the upper body 110 may be restrained. At this time, the position of the upper body 110 may be sensed through a first sensor 141 and a second sensor 142.

Next, the first sensor 141 and the second sensor 142 will be described in detail by referring to FIG. 11 to FIG. 14. FIG. 11 to FIG. 14 are drawings showing driving images of the dial-type control apparatus in accordance with one embodiment of the present inventive concept.

The first sensor 141 is installed at the each tooth unit of the first toothed surface 111a of the upper body 110 and the second sensor 142 is installed at one of the teeth of the second toothed surface 121a of the lower body 120 are illustrated on the drawing. However, the positions of the installations and the number of the first sensor 141 or the second sensor 142 may be differently selected according to needs, and various combinations may be provided. For example, the first sensor may be installed at the lower body 120 and the second sensor may be installed at the upper body 110, and the first sensor and the second sensor may be installed at positions other than the first toothed surface 111a or the second toothed surface 121a. In addition, the first sensor 141 may be installed at one of the teeth and the second sensor 142 may be installed at the each tooth unit.

The first sensor 141 and the second sensor 142 are capable of sensing each other. As one example, the first sensor 141 may be a magnetic presence having magnetic properties, and the second sensor 142 may be a magnetic sensor configured to sense magnetic presence. However, the magnetic sensor may just be one single embodiment, and various methods of sensors such as optical sensor or resistance sensor may be used.

The touch unit 113 is capable of acknowledging and interpreting gestures being input by a user while setting an initial reference direction and using the initial reference direction as a reference. Even in a case when a same gesture is input by a user, when the relative position or the relative angle with respect to the initial reference direction is different, the gesture may be recognized as a different gesture or determined as a gesture that is not being recognized.

The initial reference direction being recognized at the touch unit 113 is desired to be set to be suitable for the posture of a user that inputs a gesture. As one example, the forward and backward directions of a vehicle may be set as the initial reference direction such that a gesture may be easily input at the touch unit 113 by a driver or a passenger on a passenger's seat. However, the initial reference direction of the touch unit 113 is rotated as the touch unit 113 is rotated along with the upper body 110, and the reference direction that the user desires is still the forward and backward directions of the vehicle. Thus, the gesture being input at the touch unit 113 regardless of the rotation of the upper body 110 is recognized while having the forward and backward direction of the vehicle as a reference, and the above is in accord with the intension of the user.

The dial-type control apparatus 100 in accordance with one embodiment of the present inventive concept is capable of understanding the degree of rotation of the upper body 110 by acknowledging the position of the first sensor 141 by the second sensor 142. The reference direction of calibration is then set by calibrating the initial reference direction as much as the calculated rotation angle. Next, the gesture may be interpreted by use of the calibrated reference direction that is reset. As one example, in a case when the upper body 110 is rotated by about 90 degrees, the initial reference direction as well is rotated by about 90 degrees, and the gesture may be interpreted accordingly after setting the calibrated reference direction by rotating the initial reference direction by about −90 degrees.

Referring to the drawing, FIG. 11 illustrates a state in which the second sensor 142 is in acknowledgement of No. 1 of the first sensor 141-1 of the number of first sensors by the second sensor 142. At this time, an assumption is made that the state of the No. 1 of the first sensor 141-1 corresponding with respect to the second sensor 142 is in a state when the touch unit 113 is disposed in accord with respect to the initial reference direction. That is, the state is referred to as the upper body 110 being positioned such that the reference direction with which the touch unit 113 acknowledges a gesture is arranged toward the forward and backward directions of the vehicle.

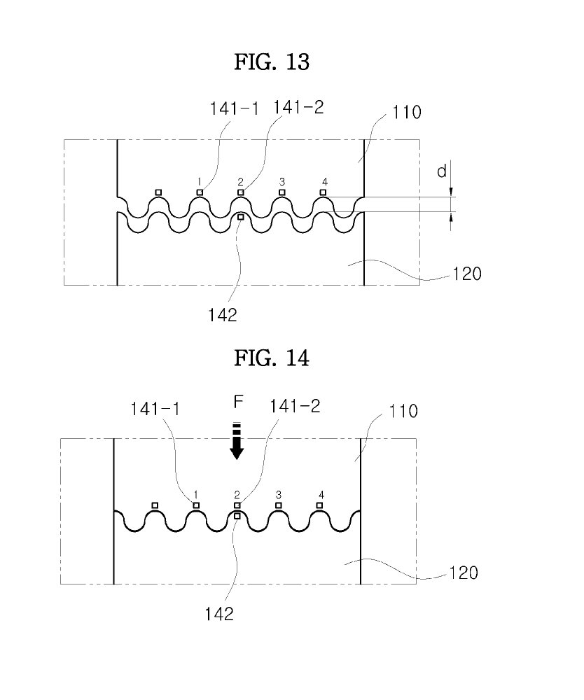

FIG. 13 illustrates a state in which a No. 2 of the first sensor 141-2 is being recognized by the second sensor 142. That is, the first sensor 141 is moved by 1 pitch toward a clockwise direction, as the pitch is referred to as a distance in between a ridge and an adjacent ridge or in between a rib and an adjacent rib. The reference direction, that is, the forward and backward directions of the vehicle, of a desired gesture by a user while the upper body 110 is rotated by the 1 pitch is in difference with respect to the initial reference direction of the touch unit 113 by a predetermined angle. At this time, if the initial reference direction of the touch unit 113 is calibrated by the difference of the calculated angle from the forward and backward direction of the vehicle, the reference direction of the gesture desired by a user and the calibrated reference direction being used as a reference being used for an input from the touch unit 113 may be in accord with respect to each other.

The angle by which the initial reference direction of the touch unit 113 is rotated at the time of when the upper body 110 is rotated by the 1 pitch may be distinguished by the number of the pitches from the total of 360 degrees. As one example, in a case when the total of 36 pitches is prepared, the initial reference direction of the touch unit 113 at the time of when the upper body 110 is rotated by the 1 pitch toward a clockwise direction is rotated by about 10 degrees toward the clockwise direction. The difference of about 10 degrees is considered a size that may sufficiently affect the degree of accuracy of the rate of acknowledgment of the gesture being recognized at the touch unit 113, and thus the initial reference direction of the touch unit 113 is desired to be calibrated. Thus, the touch unit 113, instead of interpreting a gesture while having the initial reference direction as a reference, may interpret the gesture by setting the outcome of the initial reference direction being rotated toward a counter-clockwise direction as the reference direction of calibration. The interpretation of a gesture that is in accord with the intension of a user may be provided by use of the method as such.

FIGS. 11 to 13 are flow charts showing images of the 1 pitch movement toward a clockwise direction as the handle surface 112 of the upper body 110 is gripped by a user. On FIG. 11, the first toothed surface 111a and the second toothed surface 121a are spaced apart with respect to each other by a certain distance ‘d’ without being firmly coupled into each other, as a smooth sense of manipulation may be provided to a user while elastic force is provided at the upper body 110 by the elastic member 132.

FIG. 12 shows an intermediate process of proceeding to the next tooth, and the second sensor 142 is in a state not being able to sense anything. FIG. 13 illustrates a state in which the second sensor 142 acknowledges the No. 2 of the first sensor 141-2 as the upper body 110 is moved by the one pitch toward a clockwise direction. As one example, a user may be able to move toward the 1 pitch direction from an UI, that is, a User Interface, by rotating the upper body 110.

FIG. 14 illustrates a state in which the upper body b110 is pushed by a user. The first toothed surface 111a and the second toothed surface 121a may be in contact with respect to each other as the elastic member 132 is compressed by a virtual force ‘F’. As illustrated on FIG. 13, when the virtual force ‘F’ is removed, the upper body 110 and the lower body 120 are reinstated to a state in which the upper body 110 and the lower body 120 are spaced apart with respect to each other by the certain distance ‘d’. As one example, as illustrated on FIG. 14, a user may be able to select the current UI by pushing the upper body 110.

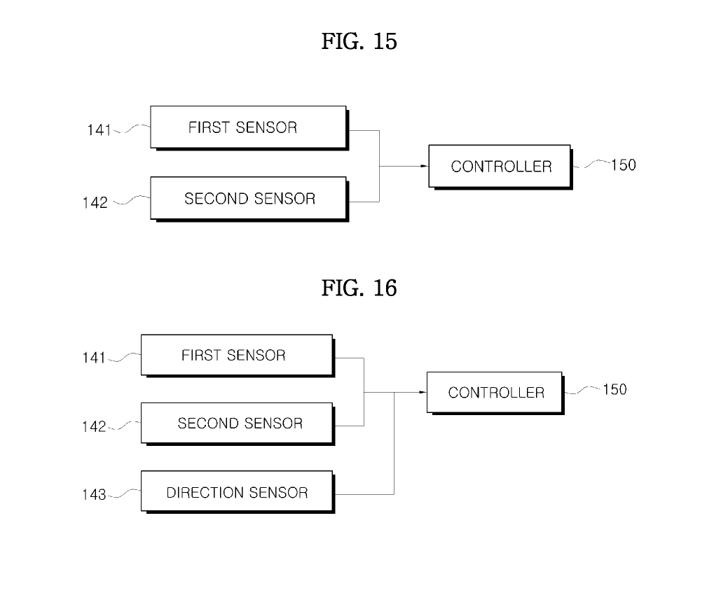

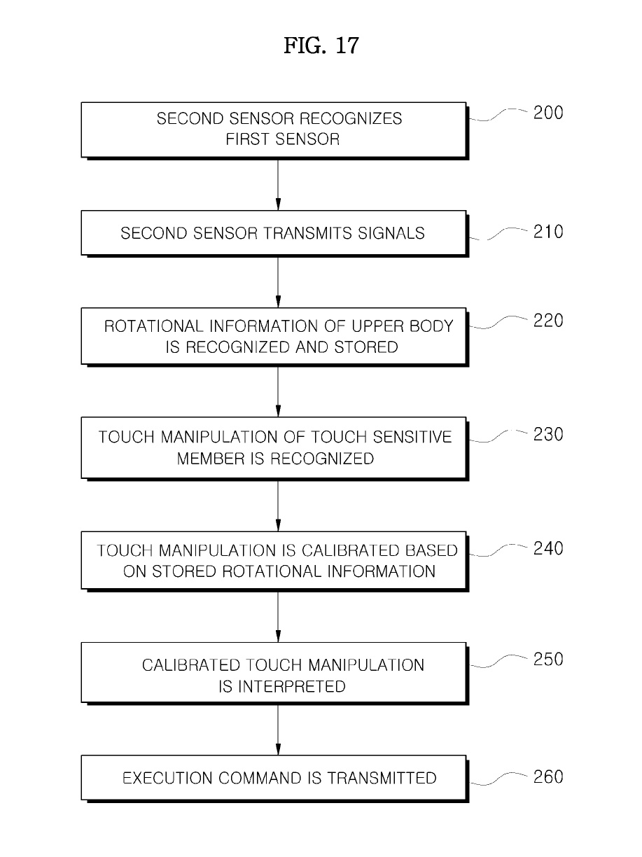

Next, referring to FIGS. 15 to 17, a control method of a vehicle having the dial-type control apparatus 100 in accordance with one embodiment of the present inventive concept will be described.

A vehicle in accordance with one embodiment of the present inventive concept may include a controller 150 configured to acknowledge the information related to the degree of rotation of the upper body 110 by the signal being input from a sensing operation in between the first sensor 141 of the upper body 110 and the second sensor 142 of the lower body 120.

The first sensor 141 and the second sensor 142 are capable of transmitting the information, as one example, the information related to a rotational angle, related to the degree of rotation of the upper body 110 by use of sensing operations to the controller 150. As one example, the first sensor 141 may include a plurality of sensor components as to be distinguished by different signs with respect to each other at an outer circumference of the upper body 110, and the second sensor 142 is capable of transmitting signals that are different with respect to each other according to the first sensor 141 that is being connected to the second sensor 142.

In certain embodiments, the first sensor 141 may be a plurality of resistors having different resistances with respect to each other, and the second sensor 142 may be a resistance sensor provided such that a current may flow while connected to the first sensor 141. The controller 150 is capable of predicting the resistance of the first sensor 141 by measuring the flowing current or voltage at the time when connected to the first sensor 141. Thus, the understanding of which one of the first sensors 141 is being connected to the second sensor 142 may be recognized, and based on the information above, the information related to the degree of rotation of the upper body 110 from an initial position may be obtained.

The plurality of first sensors 141 may be disposed at an external circumference of the upper body 110 at an equal interval with respect to each other. The second sensor 142 is configured to transmit signals each time when the first sensor 141 is recognized, and the controller 150 may be able to obtain the rotational information of the upper body 110 based on the signals as such. However, Additional information related to which direction the upper body 110 is rotated may be needed.

In certain embodiments, a direction sensor 143 may further be included as to provide information related to rotational directions of the upper body 110. The direction sensor 143 may be able to transmit signals that are capable of distinguishing rotational directions of the upper body 110. With respect to the direction sensor 143, the technologies that are published in the related technological fields may be used. As one example, the plurality of resistors provided at the upper body 110 and having different resistances with respect to each other, as well as the resistance sensor provided at the lower body 120 and through which a current flows while connected to the resistor, may be included. The detailed descriptions of the above will be substituted with the descriptions with respect to the first sensor 141 and the second sensor 142.

The control method in accordance with one embodiment of the present inventive concept in the order of time is as follows.

As the upper body 110 s rotated, the first sensor 141 is recognized by the second sensor 142 (200), and the second sensor 142 transmits signals accordingly (210). At this time, the second sensor 142 may transmit same signals each time the first sensor 141 is recognized, or may transmit different signals that are different with respect to each other according to the each first sensor 141.

The controller 150 may acknowledge rotational information of the upper body 110 through the signals above, and store the signals at a storage space (220) while the signals may be used without a process of storing. In a case when a gesture is input at the touch unit 113, the touch manipulation of the user is recognized (230). At this time, the reference direction of the gesture is calibrated (240) by withdrawing the stored rotational information of the upper body 110. By interpreting (250) the touch manipulation of the user through the calibrated reference direction as such, an execution command may be provided accordingly (260).

The dial-type control apparatus, a vehicle having the same, and a control method of the vehicle in accordance with an embodiment of the present inventive concept can increase the sense of manipulation of a user while able to decrease a burden of a wrist that the user feels, by integrating a touch unit with a handle surface.

In addition, the rate of recognition of the input information of the touch unit can be enhanced since a reference point of the touch unit is secured regardless of the degree of rotation of the handle surface.

Although a few embodiments of the present inventive concept have been shown and described, it would be appreciated by those skilled in the art that changes may be made in these embodiments without departing from the principles and spirit of the inventive concept, the scope of which is defined in the claims and their equivalents.

What is claimed is:

1. A dial-type control apparatus, comprising:
a lower body;
an upper body configured to rotate relative to the lower body; and
a touch sensitive member installed at the upper body and configured to rotate together with the upper body and to receive a touch signal of a user.

2. The dial-type control apparatus of claim 1, further comprising:
a first sensor provided at one of the upper body and the lower body; and
a second sensor provided at the other one of the upper body and the lower body,
wherein relative positions of the upper body and the lower body are identified by use of a sensing operation between the first sensor and the second sensor.

3. The dial-type control apparatus of claim 1, wherein:
a handle surface configured to deliver rotational force by a user is provided at an outer circumferential surface of the upper body, and
the touch sensitive member comprises a touch pad portion accommodated in a touch pad accommodation groove provided at an upper portion of the upper body.

4. The dial-type control apparatus of claim 2, wherein:
a first toothed surface is provided at the upper body, and a second toothed surface configured to be matingly-coupled with the first toothed surface is provided at the lower body, and
the first sensor comprises a plurality of sensor components disposed at an outer circumference of one of the upper body and the lower body at equal intervals.

5. The dial-type control apparatus of claim 2,
wherein the first sensor comprises a plurality of sensor components provided at an outer circumference of one of the upper body and the lower body, where each sensor component is distinguished by a unique sign corresponding to a unique signal, and
wherein the second sensor is configured to connect to each of the sensor components of the first sensor and to transmit the corresponding unique signal.

6. The dial-type control apparatus of claim 5, wherein:
the first sensor is provided with a plurality of resistors each having a different resistance, and
the second sensor is configured to allow a current to flow therethrough when connected to the first sensor.

7. The dial-type control apparatus of claim 3, wherein:
an upper surface of the touch sensitive member is configured to have a higher height than an end portion of the handle surface.

8. The dial-type control apparatus of claim 3, wherein an upper surface of the touch sensitive member has the same height as an end portion of the handle surface.

9. The dial-type control apparatus of claim 8, wherein:
the handle surface is provided with an inclination being inclinedly provided from an outer side of the touch sensitive member.

10. A vehicle comprising:
a dial-type control apparatus having a lower body,
an upper body configured to rotate relative to the lower body,
a touch sensitive member installed at the upper body and configured to rotate together with the upper body and to receive a touch signal of a user,
a first sensor provided at one of the upper body and the lower body; and
a second sensor provided at the other one of the upper body and the lower body;
a controller configured to recognize information regarding a degree of rotation of the upper body according to a signal transmitted as a result of a sensing operation between the first sensor and the second sensor.

11. The vehicle of claim 10, further comprising:
a direction sensor configured to recognize a rotational direction of the upper body,
wherein the first sensor comprises a plurality of sensor components provided at an outer circumference of one of the upper body and the lower body at equal intervals, and the second sensor is configured to transmit a signal by recognizing the first sensor, and
the controller is configured to recognize the information regarding the degree of rotation of the upper body through a direction sensor signal transmitted from the direction sensor and a second sensor signal transmitted from the second sensor.

12. The vehicle of claim 10, wherein:
the first sensor comprises a plurality of sensor components provided at an outer circumference of one of the upper body and the lower body, where each sensor component is distinguished by a unique sign corresponding to a unique signal, and the second sensor is configured to connect to each of the sensor components of the first sensor and to transmit the corresponding unique signal, and
the controller is configured to recognize the information about the degree of rotation of the upper body through a second sensor signal transmitted from the second sensor.

13. The vehicle of claim 11, wherein:
the direction sensor comprises a plurality of resistors each having a different resistance provided at one of the upper body and the lower body, and a resistance sensor is provided at the other one of the upper body or the lower body, the resistance sensor configured to allow a current to flow therethrough when connected to at least one of the plurality of resistors.

14. A method of controlling a vehicle provided with a dial-type control apparatus including a lower body and an upper body rotatably coupled to the lower body, the method comprising:
sensing a degree of rotation of the upper body,
recognizing touching manipulations with respect to a touch sensitive member provided at the upper body,
calibrating the touch manipulations according to the degree of the rotation of the upper body, and
executing a control method of the vehicle according to the touch manipulations.

15. The method of claim 14, wherein:
the step of sensing the degree of rotation of the upper body comprises sensing relative positions of the upper body and the lower body by use of a sensing operation between a first sensor provided at one of the upper body and the lower body and a second sensor provided at the other one of the upper body and the lower body.

16. The method of claim 15, wherein
the first sensor comprises a plurality of sensor components provided at an outer circumference of one of the upper body and the lower body, where each sensor component is distinguished by a unique sign corresponding to a unique signal, and
wherein the second sensor is configured to connect to each of the sensor components of the first sensor and to transmit the corresponding unique signal.

17. The method of claim 16, wherein the step of sensing the degree of rotation of the upper body further comprises
recognizing a signal transmitted by the second sensor, wherein the step of
sensing the relative positions of the upper body and the lower body is based on the step of recognizing.

18. The method of claim 16, wherein the sensing of the degree of rotation of the upper body comprises
receiving an upper body rotational direction signal transmitted by a direction sensor, and
recognizing a signal transmitted by the second sensor, wherein the step of sensing the relative positions of the upper body and the lower body is based on the receiving and the recognizing.

19. The method of claim 18, wherein the step of receiving the upper body rotational direction signal transmitted by the direction sensor is performed by using
a signal transmitted from a plurality of resistors provided at one of the upper body and the lower body, wherein each of the plurality of resistors has a different resistance, and
a signal transmitted from a resistance sensor provided at the other one of the upper body and the lower body, the resistance sensor allowing a current to flow therethrough when connected to the resistor.
